(19) United States
(12) Patent Application Publication
(10) Pub. No.: US 2025/0252483 A1
(43) Pub. Date: Aug. 7, 2025

(54) FASHION PRESENTATION APPLICATION SYSTEM AND OPERATING METHOD THEREOF

(71) Applicant: Ipek Ekin OGRAS, Tarsus/Mersin (TR)

(72) Inventor: Ipek Ekin OGRAS, Tarsus/Mersin (TR)

(21) Appl. No.: 18/857,622

(22) PCT Filed: Dec. 30, 2022
(86) PCT No.: PCT/TR2022/051739

§ 371 Date: Oct. 17, 2024

(30) Foreign Application Priority Data
Apr. 21, 2022 (TR) 2022/006455

(51) Int. Cl. G06Q 30/0601

(52) U.S. Cl. CPC G06Q 30/0643; G06Q 30/0623; G06Q 30/0631

(57) ABSTRACT

Disclosed herein is a fashion presentation application system and operating method thereof that offers clothes, jewelry, accessories and cosmetics to users that are suitable for their own body size and they can purchase.

This application is a National Phase entry of International Application No. PCT/TR2022/051739 under § 371 and claims the benefit of Turkish Patent Application No. TR2022/006455, filed Apr. 21, 2022, which is hereby incorporated by reference in its entirety.

### FIELD OF THE DISCLOSURE

In general, the present disclosure relates to a fashion presentation application system and operating method thereof that enables to present clothing, jewelry and accessories and cosmetics to the users that they can purchase.

In particular, the present disclosure relates to a fashion presentation application system and operating method thereof that offers clothes, jewelry and accessories and cosmetics to the users that are suitable for their own body size and they can purchase.

### BACKGROUND

Today, the ratio of electronic (online) shopping increases each passing day and various e-commerce platforms and applications are being developed with this aim. It is anticipated that online shopping will continue in an increasing trend in the coming years due to the advantages such as not having to go to the seller's shop, the cargo arriving at home/workplace, ease of return, and the possibility of using credit cards.

One of the biggest disadvantages of online shopping is that an individual has to buy clothes, jewelry and accessories or cosmetics via a device (for example, phone) without seeing/trying the same, even if they like it visually. For this reason, applications, which take the body measurements of people (e.g., height, weight, waist diameter, etc.) as input and create various virtual avatar characters (virtual representational characters) over these inputs, have been developed. Subsequently, the clothes selected for these avatars are dressed virtually and presented to the user. However, a real photo effect still cannot be obtained, and users cannot obtain the results they like on the avatars when they try these clothes on themselves. Since these avatars are created based on proportioning as standard, they do not reflect the posture characteristics such as shoulder structure, spine posture status, leg length, which can vary from person to person even if they are the same size.

In addition to this, when clothes are bought by examining the existing model photos, the buyers may experience similar disadvantages since the models are chosen from the people who are suitable for the relevant clothes and the photos/videos are blocked out.

One of the main problems in existing applications is that mobile devices that vary from user to user have various screen sizes. Therefore, images shared by different people in all existing applications are presented in different qualities and the user is misled.

An online rehearsal method for e-commerce sites is described in the document numbered TR 2017/17877 in the state of the art. The invention provides opportunity for e-commerce sites to offer their customers to visually try the products they will buy with the advantage of online rehearsal, eliminates their worries about whether it will fit to him/her in online shopping, provide more detailed rehearsal opportunities, and facilitate online clothing shopping, it is an online rehearsal method (1) for e-commerce sites comprising of the following; device camera (2) that allows the customer to upload his/her photo, a details interface (3) that allows him/her to enter additional details such as height, weight, size, shoulder width, waist and hip measurements, arm length into this photo, and a visual interface (4) that combines the image of the clothing products with the customer's photo that allows the product to be rehearsed as if it is on himself/herself, a back-side interface (5) that allows the e-commerce site to enter product photos, options, dimensions and other parameters, and an options interface (6) for tailor processes such as shortening the cloth, adding accessories to the clothing product that he/she is rehearsing. In said document, it is possible to enter detailed information for the user's body measurements, but there is still a display on a virtual avatar created from the photo.

Clothing, clothing codes and a mobile application for all ideas and commercial shopping in these fields are described in the document numbered TR 2019/20008 which is another document in the state of the art. This invention is a clothing recommendation service that users use as a member after installing the same on their mobile devices (smartphone or tablet). It relates to a mobile application system which provides inspiring options for users when shopping for clothes suitable for a certain dress code, allows them to get unique suggestions online by requesting a match from other member users or a special stylist chosen according to their membership level, offers special discounts with contracted brand options and directs them to the relevant selling platform(s), enables users to make decisions in a short time by making the right choices. However, it is not possible for people to see the clothes they like on people close to their own body size in said invention.

A wardrobe-clothing application is suggested in document numbered TR 2019/06135. It is a system that supports the selection of clothing by keeping a record of the clothing items in the user's wardrobe, facilitates the selection of clothing by providing a preview on the person's avatar, and allows fashion research by using the preferred clothing types, characterized by comprising of the following; personal information entry unit (D1) where the user opens an account and performs processes of gender, height, weight, residence, username, decision unit (G1), where the user specifies his/her wish to use his/her own photo or create an avatar, user photographing unit (G2a), where the person takes his/her own photo, and avatar creation unit (G2b), which enables the creation of artificial avatars, person card with a password (D2), which is defined by the user name and by combining the user information with the images, clothing photography unit (G3), where photographs of clothes, accessories and shoes in the wardrobe are taken, photo processing unit (G4), which enables the background to be deleted from the captured photos and turned into a 3D picture, clothing identification unit (D3), where information such as the type, color and style of clothing is entered, clothing card (D4), which is created by processing visual and identification information, storage unit (V1) where the person card (D2) and clothing cards (D4) are stored by indexing, query unit (V2) where date, color, type, style, frequency queries are made from indexed information, suggestion unit (V3) in which combinations are suggested, taking into account the compatibility for a particular activity according to past personal preferences, selection unit (D5), which allows the person to choose from the previously specified types, styles and colors from the wardrobe storage unit (V1), selection display unit (G5) that allows the person to view the selection made. However, the possibility of examining the photographs taken by the person is mentioned in said invention.

On the other hand, the application of clothing simulation is disclosed in the document numbered US2002126132 A1. A targeted programmatic use so as to reduce the unrealistic effects in simulating clothing on a body is described. The invention can be applied adaptively to instances of clothing-body and clothing-clothing interaction to compensate for behavior of the simulation system that produces effects that do not reflect the actual look of a person wearing that cloth. However, the related invention still operates on a virtual avatar.

In addition, documents numbered TR 2012/12117, TR 2016/15259, TR 2016/03865, TR 2015/11462, TR 2015/01690, TR 2014/14124, TR 2018/21123,TR 2018/15663, TR 2019/16392, TR 2019/14132, TR 2019/00297, TR 2019/10113, TR 2021/003458, KR20140139901 A, US2014279289 A1 or other documents in the G06 international patent classification can be examined so as to determine the known state of the art however, it is thought that there is not a method that provides access to the images of people who buy and use the clothes, as in the present disclosure.

As a result, due to the abovementioned disadvantages and the insufficiency of the current solutions regarding the subject matter, a development is required to be made in the relevant technical field.

### SUMMARY

The present disclosure aims to solve the abovementioned disadvantages by being inspired from the current conditions.

An aim of the present disclosure is to reveal a fashion presentation application system and operating method thereof that enables to present clothing, jewelry and accessories and cosmetics to the users that they can purchase.

Another aim of the present disclosure is to reveal a fashion presentation application system and operating method thereof that offers the users, clothes, jewelry and accessories and cosmetics suitable for their own body size that they can purchase.

Another aim of the present disclosure is to reveal a fashion presentation application system and operating method thereof that enables to present clothing, jewelry and accessories and cosmetics to the users that they can purchase by showing images of people who are in their own body size and/or close to these sizes.

Another aim of the present disclosure is to reveal a fashion presentation application system and operating method thereof that allows people to follow people (body twin) who are suitable for their own body measurements and to rate their photos.

Another aim of the present disclosure is to reveal a fashion presentation application system and operating method thereof that enables potential buyers to be offered clothing, jewelry, accessories and cosmetics, even if sharing is made in different languages.

Another aim of the present disclosure is to reveal a fashion presentation application system and operating method thereof wherein images are sized and positioned according to the user's screen size.

Another aim of the present disclosure is to reveal a fashion presentation application system and operating method thereof where you can see the most liked/commented products among the clothes, jewelry, accessories, and cosmetics products in the criteria determined by yourself by following the results of the races held at regular intervals.

The structural and characteristic features of the present disclosure will be understood clearly by the following drawings and the detailed description made with reference to these drawings and therefore the evaluation shall be made by taking these figures and the detailed description into consideration.

### BRIEF DESCRIPTION OF THE DRAWINGS

FIG. 1 is a representative view of the fashion presentation application system of at least one embodiment of the present invention.

FIG. 2 is a representative view of the registration screen of the fashion presentation application system of at least one embodiment of the present invention.

FIG. 3 is a representative view of the location (map) screen of the fashion presentation application system of at least one embodiment of the present invention.

FIG. 4 is a representative view of the search screen of the fashion presentation application system of at least one embodiment of the present invention.

FIG. 5 is a representative view of the presentation screen of the fashion presentation application system of at least one embodiment of the present invention.

FIG. 6 is a representative view of my profile screen of the fashion presentation application system of at least one embodiment of the present invention.

### DETAILED DESCRIPTION

In this detailed description, the reference numbers in the figures are listed as follows:
1. Mobile Device
2. Database
3. Server
4. Software
5. Interface

Additionally, the fashion presentation application system and operating method thereof and preferred embodiments/applications are described only for clarifying the subject matter in a manner such that no limiting effect is created.

At least one embodiment of the present invention is developed for people who want to buy clothes, jewelry/accessories and make-up products (cosmetics) without having to go to the sales point and try the product, by allowing them to see the product on the members through photos and videos that are uploaded and tagged (type, brand, size, color and price information of the product) by members who have the same height, weight and size and similar fashion style as themselves, to buy the product that suits their body and fashion style directly, to find the right combination with this product and to create new styles, as well as to ensure that members are informed about the products visually and in writing through photos and videos uploaded and tagged (type, brand, size, color and price information of the product).

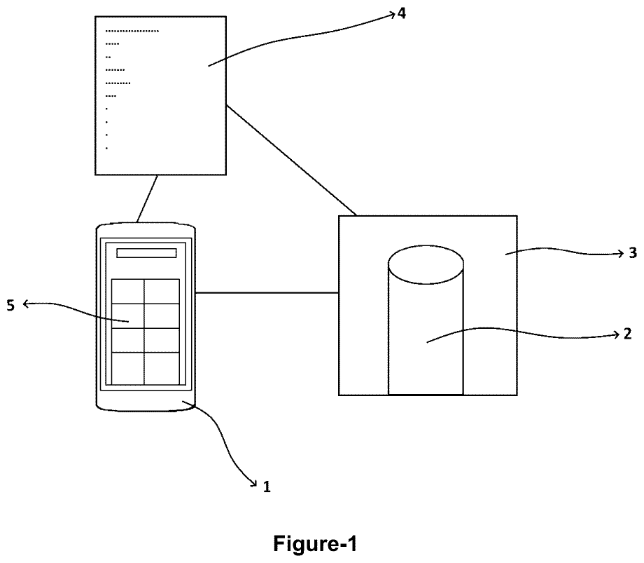

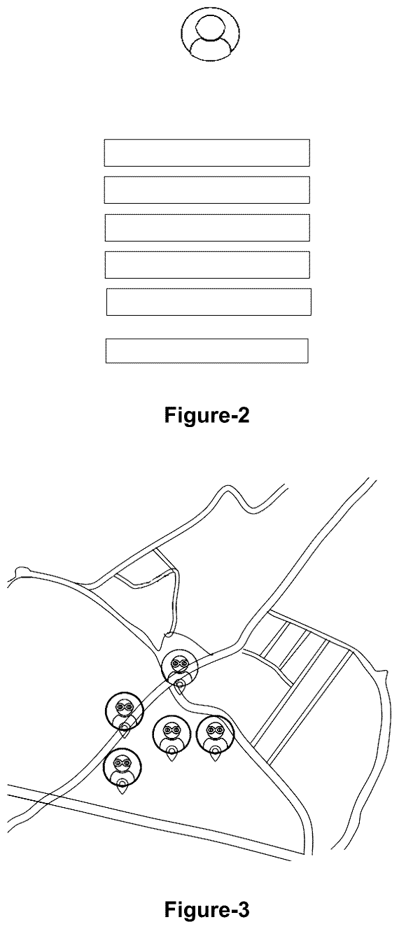

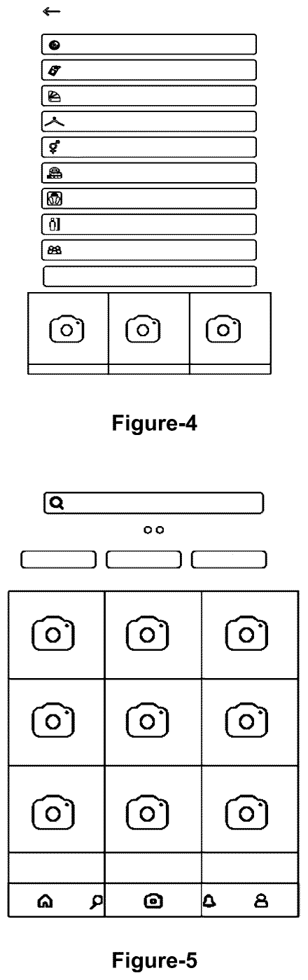

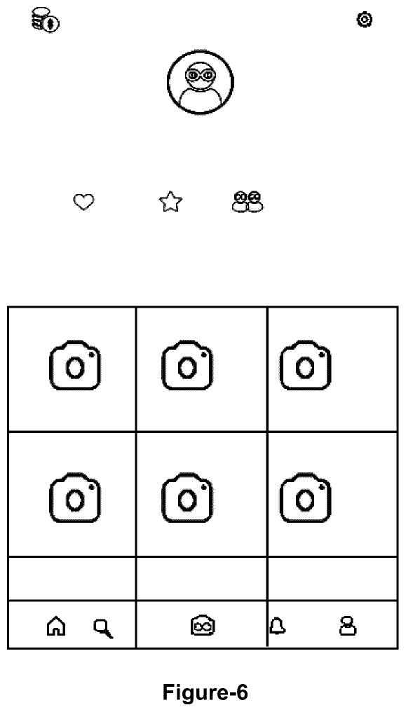

FIG. 1 is a representative view of the fashion presentation application system of at least one embodiment of the present invention, which provides the users with clothes, jewelry and accessories, and cosmetic products suitable for their own body size that they can purchase.

The fashion presentation application system comprises; mobile device (1), on which the system operates, database (2) that allows recording all the data belonging to the system, server (3) that enables the system to be delivered to users via the said mobile device (1), software (4) that enables the images of clothing, jewelry, accessories and cosmetic products shared by other users with the same and/or similar body sizes to be found in said database (2) and presented to the searcher, in accordance with the body measurements entered by the searchers and interface (5) that enables users to follow the system, share clothes, jewelry, accessories and cosmetics, and use the system by operating on the mobile device (1), via said software (4).

The application is entered for the operation of at least one embodiment of invention, the registration is made, and the presentation is listed according to the entered body criteria. The desired results are obtained by clicking/entering the icons and search bars on the pages so as to use at least one embodiment of the present invention.

Body twin finding process carried out in at least one embodiment of the present invention is the process of finding and presenting images of clothing, jewelry, accessories, and cosmetic products shared by other users with the same and/or similar body sizes in accordance with their own body measurements made by the users. The concept of body twin means the other members of the users who have the same gender, height, weight, and size as themselves, and at least one embodiment of the present invention also provides direct access via a single icon.

The database (2) mentioned in at least one embodiment of the present invention may belong to the server (3) or it may be independent.

At least one embodiment of present invention is preferably written in PHP (Hypertext Preprocessor) programming language. PHP has been preferred due to its various advantages such as being an open-source programming language, being practical and simple. PHP operating in harmony with databases (2), has special assistants such as MySQL, Server and similar that we use in our application.

PHP also provides multi-layered security. It offers the safest ways to protect sites from attacks, threats, and viruses. It has a multi-layered security system that will protect sites from bugs.

Another software (4) used in at least one embodiment of the present invention is the react native mobile software development framework. It provides multiple outputs with a single code engine and can run the same code on Web, Android and IOS.

Setting up is carried out in a plurality of countries by making cluster with activemq queue structure for processing real-time data, database MySQL for storing data in the project. Distributed system and heroku platform service are used for API services. Native development has been made for Android and IOS. Firebase cloud is used for Android notifications, Apple notification service is used for Apple notifications, and queue structure is used for notification trigger. It is designed based on the lambda architecture.

The infrastructure of the application system has been designed so as to categorize users who are members of the application and share photos according to the height, weight, size and style they specify when they become a member of the application. Therefore, the members of the application have been allowed to filter the clothes, jewelry-accessories and cosmetics on the photos shared and tagged by other members according to the type, brand, height, weight, size, color and style they will specify. It is possible for members to find clothes, jewelry, accessories and cosmetics that are suitable for their own height, weight and body measurements and tagged by other members.

The software (4) mentioned in preferred embodiments of the present invention consists of various sub-modules and provides additional technical features to at least one embodiment of present invention. Said modules can be listed as follows:
registration module, which provides the user's name, surname, gender, height, weight, body and age information, and body measurements information in case it is desired to log in to the system for the first time,
filtering and search module that enables the user to find at least one of the data such as type, brand, color, style, gender, size, weight, height, and number of likes related to the clothes, jewelry and accessories and cosmetic products that the user wants to see in mentioned database (2),
location module that enables the images of clothes, jewelry, accessories, and cosmetic products shared by other users in the location chosen by the user to be found from mentioned database (2),
presentation labeling and coordinating module that allows users to associate labels with the images of clothing, jewelry and accessories and cosmetic products they share, according to type, brand, color, size, price features and resizing and displaying the images of clothing, jewelry and accessories and cosmetic products in the database (2) independently of the screen sizes of mobile devices (1) that change from user to user,
profile and user search module that allows users to view their own profiles and find other users by searching,
tracking and scoring module that allows users to follow other users and access the images of clothes, jewelry, accessories, and cosmetics they share without searching again, to rate, like and comment on these posts,
language module that enables automatic translation such that users can see images of clothing, jewelry, accessories, and cosmetics shared in languages other than the language in which they use the system,
information module that informs users about how to use the system and/or notifications received on their profiles,
racing module, which allows users to compete based on likes, points, categories, age and/or gender at predefined time intervals, and in which the ranking is presented to the users when the defined time expires,
gift module that allows the users to show the awards given and/or to be given,
survey and research module that enables brands to evaluate their products according to quality, price and ease of use and enables customers to conduct online surveys and research, including their opinions, suggestions, and evaluations so as to determine the features of the products they will produce.

The system, which is the subject of at least one embodiment of the present invention, comprises 9 different languages, including English, Turkish, Spanish, French, Russian, Arabic, German, Portuguese and Italian, 8000 brands worldwide, 315 clothing, jewelry-accessory and cosmetics products and all body sizes used in the world for improving the fashion perception of all users in the world related to clothing, jewelry-accessory and cosmetic products and to guide fashion. Said language module can also perform automatic translations through the tagging module.

Members are allowed to rank their posts according to the number of likes and star rating on a weekly or monthly basis and to give them the title of the fashion icon of the week or month, and thus allowing other users to see their posts and interact with the member who received the title in at least one embodiment of the present invention. It is possible to give gift products or gift certificates to the member who has won the title of fashion icon of the week or month, as well as to earn money points and convert the money points they have accumulated into gift certificates, concert, cinema or theater tickets, holiday vouchers as a result of each point, comment, like or share given by the users in the application.

For example, the racing module will operate as follows:

First, the “Join the Race” icon will be added. When it is clicked here, a new page titled “racing style” appears. The features on this page are listed below:
Join the race icon (button): when you click here, an information pop-up will appear and after notification of you can choose the photo you want to participate in the race from the profile or you can choose a new photo, the person will choose the photo he/she will participate in the race by clicking one of the select from profile or add new photo buttons on the bottom line of the information text.
Two separate icons to show the female and male participants: these icons will bring the racing data by gender. For example, when the person presses the female icon, she will be able to see the racing data of the female participants.
Current week (Week 32) icon: in this button, the photos of the participants who participated in the racing in the first week of the racing will be displayed under the title of participants. As soon as 30 finalists are determined at the end of the relevant week, the participants title will change to ‘Vote for the finalists of the week 32’.
Week 33 icon: When the finalists of the week 32 are determined, the photos of the week 33 participants will be displayed under the participants title under the week 33 button. The finalists of the week 33 will be determined on Sunday, when the first place is selected among the finalists of the week 32, week 33 button will shift to the left and replace the week 32 button and the photo of the first place of the week 32 will be at the top. Under this photo, the photos of the week 33 finalists will be listed with the title Vote for the week 33 finalists. As soon as the week 33 button moves to the left, it will be replaced by the week 34 button on its right, and under this button, the photos of the week 34 participants will be displayed. This system will continue with weekly shifts and the weeks will be interchanged.
Previous racings icon: when this button is clicked, the weeks will come in order (Week 23, Week 24 . . . ) and the screen showing the finalists and the winner of the selected week will be displayed.
In addition, there will be an icon with informative text in the top right corner of the page.

The finalists will be voted for 1 week until the next Sunday, by selecting 20 of the photos that received the most likes and stars among the photos of the participants, and a total of 30 photos, 10 of which are randomly among the other photos in the list, each member will vote for a maximum of 3 of these 30 photos and will spend 1 cash point per vote, the money points given in the votes will be kept in the pool, 20 percent of the money points collected as a result of the voting will be distributed equally to the member who was the 1st selected photo, and the remaining 80 percent to the participants who voted for the 1st selected photo.

Users can determine their own profile photo and username in at least one embodiment of the present invention.

There are also various icons so as to facilitate use in the application system of at least one embodiment of the present invention. Said icons can be listed as follows:
settings icon where the user can change profile, account, and language settings, turn notifications on and off, provide suggestions and opinions, read terms of use, community rules, platform, data, cookie policies, and log out of the application,
my wallet icon showing the instant virtual money amount of the member,
number of likes icon that shows the total number of likes of the photos or videos shared by the member,
points and scoring number icon showing the cumulative arithmetic average of the points received by the member between 1 and 5 for the products tagged in the photos or videos shared by the member,
body twin icon, where members can see other members of the same height, weight, size and gender with one click without any further action,
posts icon where the total number of photos and videos shared by the member is indicated and listed,
records icon in which the total number of photos and videos the member has recorded among the allowed ones belonging to himself/herself or another member in the application is indicated and listed,
follower icon showing the number and other members following the member,
followed icon showing other members followed by the member and their number.

Mentioned my wallet icon also has the contents of becoming a member, making a member, sharing photos, making tags, the number of likes it receives, each point it gives and earning money points during the time spent in the application.

The fashion presentation application system operating method, which provides the users with clothes, jewelry and accessories, and cosmetic products suitable for their own body size that they can purchase, operates as follows:
taking the user's name, surname, gender, height, weight, body and age information and body measurements from the user for registration and recording the same in the database (2),
finding images of clothing, jewelry, accessories, and cosmetic products in the body sizes entered by the user and/or people close to these body sizes in the database (2) by means of software (4),
finding images of clothing, jewelry, accessories, and cosmetic products suitable for this filter in the database (2) by means of software (4), if the user has entered at least one of the type, brand, color, style, gender, size, weight, height, location and number of likes data related to clothing, jewelry and accessories and cosmetics products,
scaling of the images and labels of clothing, jewelry and accessories and cosmetic products found according to the screen dimensions of the mobile device (1) by the software (4),
presenting the images in the database (2) to the user with the interface (5) running on the mobile device (1) via the server (3),
making registration to the database (2) if the user has rated and/or liked the images of clothing, jewelry and accessories and cosmetic products offered.

In a preferred embodiment of the present invention, there is a process step of presenting the images of clothing, jewelry, accessories, and cosmetic products found in case of being suitable for the desired filtering on the interface (5) to the user by making translations from languages other than the language in which the user uses the application system.

In a preferred embodiment of the present invention, for the visuals in the database (2) to be presented to the user with the interface (5) running on the mobile device (1) by scaling of the images and labels of clothing, jewelry and accessories and cosmetic products found by the software (4) according to the screen dimensions of the mobile device (1) that wants to display and by the server (3), comprising of the following process steps;
measuring the distance from the top and left edge of the photo tag,
recording the measured distance as location information together with the label information,
rescaling the width and height of the photo such that it does not fall below 800×800,
scaling of tag and location information at the same rate,
fragmentation of the main skeleton of the photograph,
displaying the photograph in the lowest resolution,
increasing the clarity by recalling the photo from the location where it was recorded when the time to focus on the photo has elapsed.

An example process for a photo is as follows:
The photo is downloaded to the phone from the camera, gallery or other third party applications.
The user touches an empty spot on the photo.
A round label mark is created where touched.
If desired, the tag mark can be brought to the desired position on the photo by drag and drop method.
A pop-up opens on the blank part of the screen, not exceeding 50% of the size.
A screen opens on the pop-up where you can enter type information (shirt, shoes, trousers, glasses, etc.), brand, size, color information.
A selection is made or the relevant information is entered and the pop-up is closed.
The distance from the top and left edge of the photo tag is measured and written on the location information.
It is kept in a data together with the tag information.
The width and height of the photo is rescaled such that it does not fall below 800×800 at the post publishing stage.
The location information of the label is scales at the same rate and it is saved on the server side using a database and Cloud storages with a Restful API provider along with the post.
Photo processing and recording servers are used so as to display photo information.
The Discrete Cosine Transform (DCT) method is used for photo compression. The image processing is carried out as a stream.
The main skeleton of the photo (size information) and the lowest dimensions are divided into parts.
For the first time, the lowest resolution version of the photo is uploaded.
As long as the focus is on the photo, the remaining packets are streamed from the server to the client side, thus increasing clarity.
The publishing process is initiated.
The post is sent to the followers who follow the relevant user the most.
The post will be sent to the remaining followers as the 2^{nd}.
The post is sent to the people who are closest styles to the relevant user as the 3^{rd}.
The post is sent to all users via discover if the relevant level is high as the 4^{th}.
These publishing priorities are determined by the interactions of other inapp users.
Apache Kafka, the queue, is used so as to publish posts.
Apache Spark is used so as to prioritize the relationship of posts with users. This process is made in a distributed manner.
Users who open the post will see the photo scaled according to the screen width and height of the device they are using.
Users who open the post will see the coordinates of the tag in scaled position in proportion to the screen width and height of the device they are using.

In a preferred embodiment of the present invention, the following steps are followed so as to create the virtual avatar of the user:
recording images from 2 different cameras of the mobile device (1),

The user can turn around in front of the camera by fixing the camera such that he/she can be seen from the full length, or the user can stand still and turn around the camera to record.
deleting parts other than the human body on the images taken from both cameras with the help of the software (4),

The human body and face in the image are preprocessed by artificial intelligence software that has been trained many times before with different human bodies. The artificial intelligence deletes data outside of the human body part for performance in both images.
separating the human body parts and recording the same as matrix data related to the frames on the images taken from both cameras with the help of the software (4),

It creates a data set as matrix data associated with frames on the image for sections such as shoulder, waist, neck, eye socket, eyebrow, hair, nose, etc.
proportioning the distances of each of the body parts separated on the image to each other with the height information received from the user,
obtaining a 2-dimensional data matrix, width and height, as a result of said proportioning,

The distances of the grouped regions and points in the images to each other are calculated in two dimensions, namely X and Y, in the first stage, as width and height in proportion to the height information received from the user.
obtaining depth information separately for each separated body part by means of images taken from 2 different cameras in the same time period,

The z-axis information is obtained with the ratio of the distance difference between the cameras and the distance difference of the same point on the images obtained with different perspectives from two cameras recorded in the same time period for the calculation of the depth, in other words 3rd dimension information. This process is carried out for each point or section of the body on the images.
Saving the data matrix consisting of width, height and depth defining the 3D avatar to the database (2),

The data contained in the X, Y, Z data and the relevant body part is saved as a data set. A virtual model is created using this dataset. Virtual modeling software is also an artificial intelligence. The virtual model created by the software is a file format that standard 3D software can open and can be edited. Body lines on the created model are revised by skilled persons in 3D design so as to train artificial intelligence. The modeling is re-introduced to the artificial intelligence as a result of the revision. Modeling artificial intelligence revises threshold values for relevant regions and points. In case the modeling artificial intelligence reaches its final learning state, the learning state is no longer required. All recordings with sufficient resolution made with 3D or phones with at least 2 cameras can be modeled as 3D with this method.

Mentioned avatar can preferably be an avatar with block chain infrastructure. Primarily, it will be ensured that the accumulated money points work with an algorithm connected to the block chain system. It will be possible to create 3D digital avatars of users by using the cameras of mobile devices (1) with block chain and it will be ensured that these avatars are connected to the money points like NFTs in a unique structure with block chain technology with the help of this established system.

These avatars will be created in a structure that will include all the physical properties of the user (including the face) in the most detailed manner.

In fact, this avatar will contain all the physical measurements of the person such as height, shoulder, waist, hip in millimeters, such the user will have a 3D digitized version of himself/herself.

Furthermore, it is aimed to create these avatars in a decentralized structure, with a closed system only on the personal phone of the person, by considering complete privacy, with the logic of block chain and crypto cold wallet technology.

Therefore, a software guarantee is given such that the created avatars will not be seen by any person or organization other than the user, concerns about the privacy and confidentiality of the users' data will be completely eliminated and the confidentiality of the data regarding these avatars will be undertaken by the designer in software and legal terms.

As it is known, clothing brands now create the QR code of every product they manufacture. Herein, it is aimed to enable the users to read the QR code of the product they want to experience on their phone and to experience how the 3D image of the product looks on the avatar created on their phone with the technological infrastructure mentioned above.

Therefore, the user will have the chance to experience the product suitable for his/her body size and style without having to go to the relevant store and try the same personally and buy it online if he/she wants it, in this way, the user will be able to try different sizes or cuts of multiple products in a short time and buy the right product.

Furthermore, a digital 3D universe will be built in the block chain system, and users will be able to communicate, interact and share, do some social activities, experience products in digital stores and buy these products online through the avatars they create within this universe.

Thus, a fashion presentation application system operating method, which provides the users with clothes, jewelry and accessories, and cosmetic products suitable for their own body size that they can purchase, is revealed.

1. A fashion presentation application system comprising:
at least one mobile device on which the system is running,
at least one database, which ensures that all data belonging to the system are recorded,
at least one server that enables the system to be delivered to users via the at least one mobile device,
at least one software that enables images of clothing, jewelry, accessories, and cosmetic products shared by other users with the same and/or similar body sizes to be found in the at least one database and presented to a searcher, in accordance with body measurements entered by the searcher,
at least one interface that enables the users to follow the system, share clothes, jewelry, accessories, and cosmetics, and use the system by operating on the at least one mobile device, via the at least one software. wherein the fashion presentation application system provides the users with clothes, jewelry, accessories, and cosmetic products suitable for the users' own body sizes that the users can purchase.

2. A fashion representation application system according to claim 1, wherein the at least one software comprises at least one registration module, which provides the user's name, surname, gender, height, weight, body and age information, and body measurements for logging in to the system for the first time.

3. A fashion presentation application system according to claim 1, wherein mentioned the at least one software comprises at least one filtering and search module that enables the user to find at least one of the data selected from the group consisting of: type, brand, color, style, gender, size, weight, height, and number of likes related to the clothes, jewelry, accessories, and cosmetic products that the user wants to see in the at least one database.

4. A fashion presentation application system according to claim 1, wherein the at least one software comprises at least one location module that enables the images of clothes, jewelry, accessories, and cosmetic products shared by the other users in a location chosen by the user to be found from the at least one database.

5. A fashion presentation application system according to claim 1, wherein the at least one software comprises at least one presentation labeling and coordinating module that allows the users to (i) associate labels with the images of clothing, jewelry, accessories, and cosmetic products they share, according to type, brand, color, size, price features, and resizing, and (ii) display the images of clothing, jewelry, accessories, and cosmetic products in the at least one database independently of the screen sizes of the at least one mobile device that changes from user to user.

6. A fashion presentation application system according to claim 1, wherein the at least one software comprises at least one profile and user search module that allows the users to view the users' own profiles and find the other users by searching.

7. A fashion presentation application system according to claim 1, wherein the at least one software comprises at least one tracking and scoring module that allows the users to follow the other users and access the images of clothes, jewelry, accessories, and cosmetics they share, to rate, like, and comment on posts, without searching again.

8. A fashion presentation application system according to claim 1, wherein the at least one software comprises at least one language module that enables automatic translation such that the users can see the images of clothing, jewelry, accessories, and cosmetics shared in languages other than a language in which the users use the system.

9. A fashion presentation application system according to claim 1, wherein the at least one software comprises at least one information module that informs the users about how to use the system and/or notifications received on the users' profiles.

10. A fashion presentation application system according to claim 1, wherein the at least one software comprises at least one racing module, which allows the users to compete based on likes, points, categories, age, and/or gender at predefined time intervals, and in which the ranking is presented to the users when the predefined time intervals expire.

11. A fashion presentation application system according claim 1, wherein the at least one software comprises at least one gift module that allows the users to show awards given and/or to be given.

12. A fashion presentation application system according to claim 1, wherein the at least one software comprises at least one labeling module that allows the users to associate labels with the images of clothing, jewelry, accessories, and cosmetics the users share, according to type, brand, color, size, and price.

13. A fashion presentation application system according to claim 1, wherein the at least one software comprises at least one survey and research module that (i) enables brands to evaluate their products according to quality, price, and ease of use, and (i) enables customers to conduct online surveys and research, including their opinions, suggestions, and evaluations so as to determine features of products the brands will produce.

14. A fashion presentation application system operating method, the method comprising:
taking a user's name, surname, gender, height, weight, body and age information, and body measurements from the user for registration and recording in a database,
finding images of clothing, jewelry, accessories, and cosmetic products in body sizes entered by the user and/or people close to the body sizes in the database via software,
finding the images of clothing, jewelry, accessories, and cosmetic products suitable for a filter in the database via the software, if the user has entered at least one of: type, brand, color, style, gender, size, weight, height, location and number of likes data related to the clothing, jewelry, accessories, and cosmetics products,
scaling of the images, and labels, of clothing, jewelry, accessories, and cosmetic products found according to screen dimensions of a mobile device by the software,
presenting the images in the database to the user with an interface running on the mobile device via a server, and
making registration to the database if the user has rated and/or liked the images of clothing, jewelry, accessories, and cosmetic products offered,
wherein the method provides the users with clothes, jewelry, accessories, and cosmetic products suitable for the users' own body sizes that the users can purchase.

15. A fashion presentation application system operating method according to claim 14, further comprising: presenting the images of clothing, jewelry, accessories, and cosmetic products found where suitable for the filter on the interface to the user by translating from languages other than the language in which the user uses the application system.

16. A fashion presentation application system operating method according to claim 14, wherein visuals in the database are presented to the user with the interface running on the mobile device by scaling of the images and labels of clothing, jewelry, accessories, and cosmetic products found by the software according to the screen dimensions of the mobile device that wants is displayed and by the server, wherein the method further comprises:
measuring a distance from a top and left edge of a photograph tag,
recording the measured distance as location information together with the label information,
rescaling a width and height of the photograph such that the photo's dimensions do not fall below 800×800,
scaling of the tag and the location information at a same rate,
fragmentation of a main skeleton of the photograph,
displaying the photograph in the lowest resolution, and
increasing clarity by recalling the photograph from the location where the photograph was recorded when a time to focus on the photograph has elapsed.

17. A fashion presentation application system operating method according to claim 14, further comprising:
recording images from two different cameras of the mobile device,
deleting parts other than the human body on the images taken from both of the two cameras, via the software,
separating the human body parts and recording the human body parts as matrix data related to frames on the images taken from both of the two cameras, via the software,
proportioning distances of each of the body parts separated on the image to each other with height information received from the user,
obtaining a two-dimensional data matrix comprising width and height, as a result of the proportioning,
obtaining depth information separately for each separated body part via the images taken from the two different cameras in a same time period, and
saving a three-dimensional data matrix comprising width, height, and depth, defining a three-dimensional avatar to the database.
